(19) United States
(12) Patent Application Publication
(10) Pub. No.: US 2003/0001476 A1
(43) Pub. Date: Jan. 2, 2003

(54) Field emission display

(76) Inventor: Christopher Chang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,078

(22) Filed: Jun. 10, 2002

(30) Foreign Application Priority Data
Jun. 29, 2001 (TW) 90115890

(51) Int. Cl. H01J 1/02

(52) U.S. Cl. 313/309

(57) ABSTRACT

A field emission display, having a cathode substrate with column lines thereon, a resistance layer covering the column lines, and gate rows crossing over the row lines. An insulation layer is located under the gate row lines to isolate the gate row lines. The resistance layer between the gate row lines is exposed. The insulation layer and the gate row lines have openings therein to expose the resistance layer. Micro-tips are formed on the exposed resistance layer in the openings. An anode substrate is located on the gate row lines and spaced with a vacuum space.

### CROSS REFERENCE TO RELATED APPLICATIONS

This application claims the priority benefit of Taiwan application serial no. 90115890, filed Jun. 29, 2001.

### BACKGROUND OF INVENTION

1. Field of the Invention

The invention relates in general to a display, and more particularly, to a planar field emission display that prevents abnormal discharge.

2. Description of the Related Art

A display is a common apparatus in daily lives. An image is displayed to a user via a display. There are various kinds of displays, of which the cathode ray tube (CRT) is the most common one. However, the conventional cathode ray tube display occupies a large space. Lately, a liquid crystal display (LCD) occupying a smaller space has been developed. In addition, a field emission display applying the operation theory of cathode ray tube, but retaining the characteristics of liquid crystal display, has also been developed. The images of the field emission display are constructed by pixels, and the space occupied by the field emission display is smaller than that of cathode ray tube display.

FIG. 1 shows the operation theory of a conventional field emission display. In FIG. 1, a micro-tip 100 is formed on a resistance layer 104. A net column line 102 is under the resistance layer 104. On top of the micro-tip 100, there is a gate row line 106. The gate row line 106 has a hole 108 allowing the tip of the micro-tip 100 to be exposed. An anode plate 110 is formed on the gate row line 106. In addition to a display substrate, the anode plate 110 further comprises a conductive layer and a fluorescent layer. The anode plate 110 is made to conduct by applying a positive voltage to the conductive layer thereof.

To discharge the micro-tip 100 and display on the anode plate 110, the column line 102 is grounded and a voltage is applied to the gate row line 106 to induce the tip of the micro-tip 100 to emit electrons. The emitted electrons are accelerated and attracted by the anode electrode plate 110 to bombard the fluorescent layer of the anode plate 110, which then emits fluorescent light. The fluorescent light transmits through the substrate to display the image pixels. The light beam of the pixels constructs an image. This display theory is similar to that of the cathode ray tube display. However, due to the different discharge structure and a thinner space, the field emission display is a planar display.

In the conventional field emission display, the formation of the cathode requires six photolithography and etching processes and six thin film deposition processes. Once formed, the cathode is sealed with the anode by a glass paste. A top view of the cathode of the field emission display is shown in FIG. 2A. The cathode of the field emission display comprises a net column line 102 and a resistance layer 104. The resistance layer 104 has several micro-tips 100 thereon. The micro-tips 100 are cone shaped structures, for example. At the same height of tips of the micro-tips 100, a gate row line 106 is formed. A hole 108 corresponding to the micro-tips 100 is formed in the gate row line 106. An insulation layer 112 is formed under the gate row line 106 for isolation.

In FIG. 2B shows a cross-sectional view of the conventional field emission display cutting along the line I-I in FIG. 2A. In FIG. 2B, the conventional field emission display has a substrate 90. A net column line 102 is formed on the substrate 90. A resistance layer 104 is formed on the substrate 90 and covers the column line 102. An insulation layer 112 with openings exposing the resistance layer 104 is formed on the resistance layer 104. A micro-tip 100 is disposed in the opening. Gate row lines 106 are formed on the insulation layer 104. Micro-tips 100 are formed on the exposed resistance layer 104 in the openings. Openings corresponding to the gate row line 106 are formed around the tips of the micro-tips 100. The gate row lines 106 are spaced with a distance. After formation of the cathode, an anode plate 110 is formed on the gate row lines 106 with a vacuum space in between.

Being induced by the gate row lines 106, the tips of the micro-tips 100 emit electrons. Being accelerated by the attractive of the anode plate 110, the electrons bombarding the fluorescent material of the anode plate 110 to generate fluorescent light. During the process of bombardment by the electrons or the electron emission of the micro-tips 100, residual formed on the micro-tips 100 may produce charged particles. Such charged particles falling on the silicon oxide between the gate row lines may cause charge accumulation. When the charge accumulation reaches a certain level, a short circuit or abnormal discharge on adjacent gate row lines may occur. The abnormal discharge occurs between an operating gate row line and adjacent non-operating gate row line. The voltage between an operating gate row line and adjacent non-operating gate row line causes the accumulated charges to discharge abnormally. The short circuit and the abnormal discharge on adjacent gate row lines damage the device. Consequently, defects like non-uniform brightness or open circuit of the field emission display may occur.

### SUMMARY OF INVENTION

The objective of the present invention is to provide a field emission display wherein the insulation layer on areas uncovered with the gate row lines of the cathode plate is removed and the resistance layer under the insulation layer is thus exposed. When the field emission display is operating, excessive charges falling on the regions between the gate row lines are grounded through the resistance layer and the ground line. Therefore, the short circuit on adjacent gate row lines or the abnormal discharge damaging the field emission display is prevented. The endurance of the field emission display is thus enhanced.

The field emission display provided by the invention comprises a cathode substrate, a plurality of column lines formed on the substrate, a resistance layer covering the column lines, a plurality of gate row lines crossing over the column lines, an insulation layer under the gate row lines and a plurality of micro-tips. The insulation layer is formed to isolate the gate row lines. However, the resistance layer between the gate row lines is exposed. The resistance layer within openings of the gate row lines and the insulation layer is exposed. The micro-tips are formed on the resistance layer in the openings. An anode plate is formed on the gate row lines with a vacuum space in between.

A cathode of field emission display is provided in the invention, comprising a cathode substrate, a plurality of column lines formed on the cathode substrate, a resistance layer covering the column lines, gate row lines crossing over the column lines, and an insulation layer under the gate row lines for isolation. The resistance layer between the gate row lines is exposed. The insulation layer and the gate row lines have openings therein to expose a portion of the resistance layer. Micro-tips are formed in the openings of the exposed resistance layer.

The micro-tips above-mentioned include cone shape structures of which tips may emit electrons.

In the invention, the insulation layer between the gate row lines is removed to expose the resistance layer. Without increasing fabrication processes, the short circuit or abnormal discharge between the gate row lines can be avoided.

Both the foregoing general description and the following detailed description are exemplary and explanatory only and are not restrictive of the invention, as claimed.

### BRIEF DESCRIPTION OF DRAWINGS

FIG. 1 shows the operation theory of a conventional field emission display;

FIG. 2A shows a top view of the cathode of a conventional field emission display;

FIG. 2B shows a crosssectional view of a conventional field emission display cutting along I-I″ of FIG. 2A; and

FIG. 3 shows a cross-sectional view of the field emission display according to a preferred embodiment of the present invention.

### DETAILED DESCRIPTION

In the invention, the insulation layer covering the area , which is not covered with the gate row lines of a cathode of a field emission display formed by six photolithography and etching processes, is removed to expose the underlying resistance layer. The method of removing the insulation layer includes etching. When the field emission display is operated, the excessive accumulated charges falling on the area between the gate row lines are grounded through the resistance layer or a ground line. Therefore, the short circuit and abnormal discharge occurring between the gate row lines are effectively avoided. The damage caused thereby is consequently prevented to enhance the endurance of the field emission display.

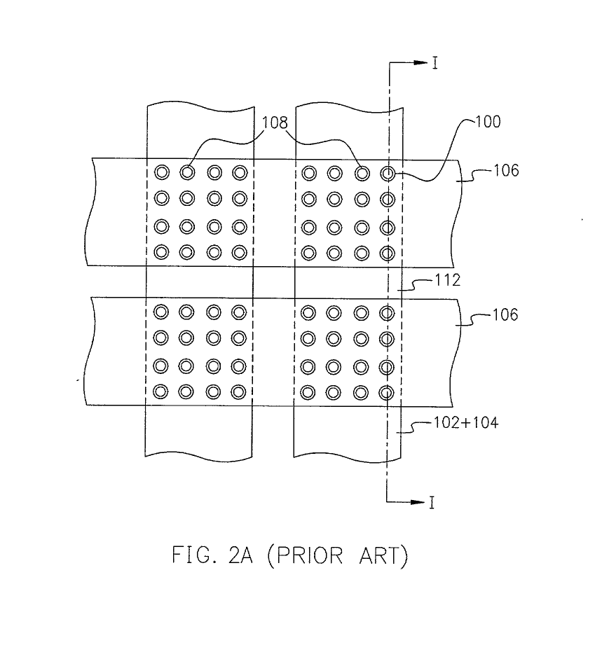

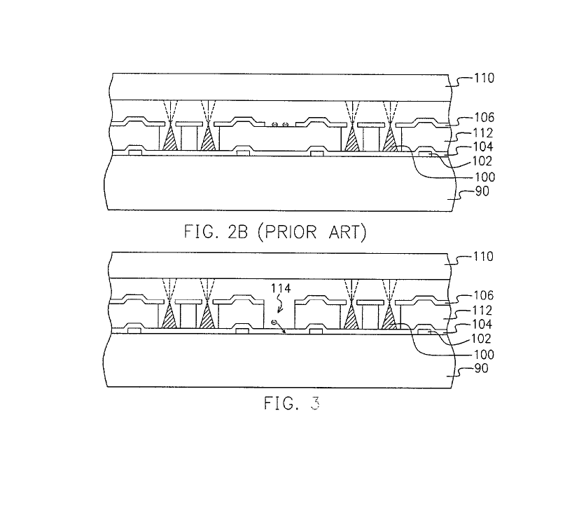

The following is an embodiment to introduce the invention. FIG. 3 shows a cross-sectional view of a field emission display according to the embodiment of the present invention. In FIG. 3, the field emission display is similar to the one shown in FIG. 2B. The difference of the invention is the formation of a trench or opening 114 that effectively prevents a short circuit or abnormal discharge from occurring.

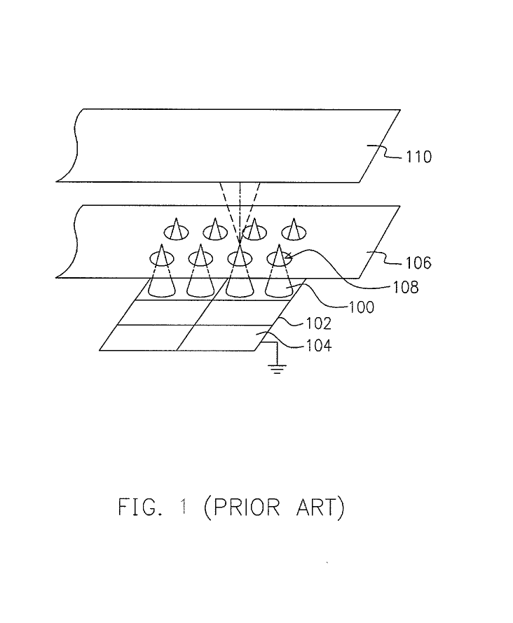

The field emission display of the present invention includes a cathode substrate 90, for example, a silicon oxide glass. A column line 102 is formed on the cathode substrate 90. In the embodiment, the column line 102 is the net structure as shown in FIG. 1 such that a plurality of lumps appears in the cross-sectional view in FIG. 3. A resistance layer 104 is formed to cover the column line 102. The resistance layer 104 includes a doped silicon layer, for example. The doped silicon layer can be formed by deposition of a polysilicon layer, followed by a doping step. The doping step can also be performed in situ to forming the polysilicon layer. The resistance of the resistance layer depends on the doping level.

Micro-tips 100 having a conical shape, for example, are formed on the resistance layer 104. The micro-tips 100 are made of chromium (Cr), for example. An insulation layer 112 is formed, covering the resistance layer 104. The insulation layer 112 is made of silicon oxide, for example. The tips of the micro-tips 100 may be exposed. Openings are formed in the insulation layer 112 such that the micro-tips 100 located in the openings of the insulation layer 112 are exposed. A conductive layer (not shown in FIGS.) is formed on the insulation layer 112. The conductive layer is patterned as a gate row line 106. The insulation layer 112 is under the gate row line 106.

While forming the cathode of the field emission display, other parts may be formed simultaneously. While forming the contact window, the insulation layer 112 between the gate row lines 106 is consequently removed to form an opening or a trench 114 to expose the resistance layer 104.

The formation of the trench 114 is the key feature of the invention. There are several methods for forming the trench 114. The function of the trench 114 has been mentioned above. Redundant charges falling on the regions between the gate row lines 106, as the resistance layer 104 is exposed to the redundant charges, are thus directed to the column line 102 connected to ground via the resistance layer 104. The accumulated charges are thus released from the spaces between the gate row lines 106, and the short circuit and abnormal discharge are effectively prevented.

The method for implementing the invention includes removing the insulation layer 112 between the gate row lines 106 only. That is, no additional process is introduced and the problems of short circuit or abnormal discharge are effectively resolved.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A field emission display, comprising:
a cathode substrate;
a plurality of column lines on the cathode substrate;
a resistance layer, covering the column lines;
a plurality of gate row lines across the column lines;
an insulation layer under the gate row lines to isolate the gate row lines, wherein the gate row lines and the insulation layer have a plurality of openings therein to expose a portion of the resistance layers;
a plurality of micro-tips on the resistance layer in the openings to generate electrons; and
an anode substrate, located on the gate row lines to construct a vacuum space between the anode substrate and the cathode substrate.

2. The field emission display according to claim 1, wherein the cathode substrate includes a glass substrate.

3. The field emission display according to claim 1, wherein the resistance layer includes a doped silicon layer.

4. The field emission display according to claim 1, wherein the insulation layer includes an oxide layer.

5. The field emission display according to claim 1, wherein the anode substrate includes a fluorescent layer and a conductive layer to accelerate electrons to bombard the fluorescent layer.

6. The field emission display according to claim 1, wherein the micro-tips are cone shaped.

7. A cathode of a field emission display, comprising:
a cathode substrate;
a plurality of column lines on the cathode substrate;
a resistance layer covering the column lines;
a plurality of gate row lines across the column lines;
an insulation layer located under the gate row lines for isolation, wherein the insulation layer has a trench exposing the resistance layer between the gate row lines; and
a plurality of micro-tips located on the exposed resistance layer in the trench to generate electrons.

8. The cathode of a field emission display according to claim 7, wherein the cathode substrate includes a glass substrate.

9. The cathode of a field emission display according to claim 7, wherein the resistance layer includes a doped silicon layer.

10. The cathode of a field emission display according to claim 7, wherein the insulation layer includes an oxide layer.

11. The cathode of a field emission display according to claim 7, wherein the micro-tips are cone shaped.

12. A method of forming a cathode of a field emission display, wherein the field emission display has a resistance layer formed on a substrate, an insulation layer formed on the resistance layer, a plurality of gate row lines on the insulation layer and a plurality of micro-tips on the resistance layer in the insulation layer, the characteristic of that: removing the uncovered insulation layer between the gate row lines to expose the resistance layer.
